(19) United States
(12) Patent Application Publication
(10) Pub. No.: US 2025/0309385 A1
(43) Pub. Date: Oct. 2, 2025

(54) GAS MITIGATION FOR BATTERY SYSTEMS

(71) Applicant: FORD GLOBAL TECHNOLOGIES, LLC, Dearborn, MI (US)

(72) Inventors: Qian ZHOU, Northville, MI (US); Gang GUO, Saline, MI (US); Kent SNYDER, Dearborn, MI (US); Giovanni CAVATAIO, Dearborn, MI (US)

(21) Appl. No.: 18/619,122

(22) Filed: Mar. 27, 2024

(51) Int. Cl. H01M 10/52; H01M 10/052; H01M 50/105; H01M 50/121; H01M 50/124

(52) U.S. Cl. CPC H01M 10/52; H01M 10/052; H01M 50/105; H01M 50/121; H01M 50/1243

(57) ABSTRACT

This disclosure relates to systems for hydrogen sulfide mitigation. A battery cell or plurality of battery cells in a battery pack with a solid electrolyte sandwiched between an anode and a cathode are presented. A coating is applied to an interior surface of the sulfur-containing lithium-based rechargeable battery cell. The coating is configured to precipitate hydrogen sulfide gas responsive to moisture ingress in the cathode and exude sulfur dioxide and water external to the sulfur-containing lithium-based rechargeable battery cell.

### TECHNICAL FIELD

This disclosure relates to methods of byproduct mitigation for a battery pack.

### BACKGROUND

The lithium-sulfur (Li—S) battery has promising theoretical specific energy and availability. A challenge, however, associated with both solid-state and lithium-sulfur batteries is the potential formation of hydrogen sulfide (H₂S) gas when these batteries are exposed to water or moisture. This is due to the interaction between the sulfide-based solid-state electrolyte or the sulfur cathode and moisture, leading to the generation of H₂S. The release of H₂S may reduce performance and longevity of the battery systems.

### SUMMARY

In one aspect of the disclosure a sulfur-containing lithium-based rechargeable battery cell is presented. The sulfur-containing lithium-based rechargeable battery cell has a cell assembly including a casing having a sulfidolytic coating applied to an interior surface thereof, and a cell, having an anode, a cathode, and an electrolyte sandwiched therebetween. The sulfidolytic coating is configured to precipitate hydrogen sulfide gas responsive to moisture ingress in the cathode such that the sulfidolytic coating exudes sulfur dioxide and water into the casing. The sulfidolytic coating may include a catalyst material. The catalyst material may be Ni/Ce, Cu/Zeolite, Fe/Zeolite, or combinations thereof. The electrolyte may be inorganic solid electrolyte, solid polymer electrolyte, or a composite polymer electrolyte. The casing may be made of a composite. In other embodiments, the casing may be polymer-based. The sulfidolytic coating may be applied using atomic layer deposition, vapor deposition, or 3D printing.

In another aspect of the disclosure a battery pack is presented. The battery pack has a plurality sulfur-containing lithium-based rechargeable battery cell assemblies defining a stack, and a sulfidolytic coating, on opposite exterior surfaces of the stack. The sulfidolytic coating is configured to precipitate hydrogen sulfide gas responsive to moisture ingress in the sulfur-containing lithium-based rechargeable battery cell assemblies such that the sulfidolytic coating exudes sulfur dioxide and water. The sulfidolytic coating may include a catalyst material. The catalyst material may be Ni/Ce, Cu/Zeolite, Fe/Zeolite, or combinations thereof. The sulfur-containing lithium-based rechargeable battery cell assemblies may include an electrolyte. The sulfidolytic coating may be applied using atomic layer deposition, vapor deposition, or 3D printing. In some embodiments, the battery pack may further comprise an enclosure around the stack configured to permit selective venting of sulfur dioxide and water.

In yet another aspect of the disclosure, a battery is presented. The battery has a sulfur-containing lithium-based rechargeable battery cell having an anode, a cathode, with an electrolyte sandwiched therebetween, and a coating on opposite exterior surfaces of the sulfur-containing lithium-based rechargeable battery cell configured to hydrolyze hydrogen sulfide gas into sulfur dioxide and water. The coating may include a catalyst material. The catalyst material may be one of Ni/Ce, Cu/Zeolite, Fe/Zeolite, or combinations thereof. The electrolyte may be an inorganic solid electrolyte, solid polymer electrolyte, or a composite polymer electrolyte. The coating may be applied using atomic layer deposition, vapor deposition, or 3D printing. The battery may be a pouch cell. The battery may be packaged with a plurality of battery cell assemblies defining a stack.

### BRIEF DESCRIPTION OF THE DRAWINGS

FIG. 1 is a diagram of an experimental setup;

FIG. 2A is a table of sensor readings for control samples;

FIG. 2B is a graph of sensor readings for control samples;

FIG. 3A is a table of sensor readings for catalyst materials investigated for use with any one or more embodiments of the disclosure;

FIG. 3B is a graph of sensor readings for catalyst materials investigated for use with any one or more embodiments of the disclosure;

FIG. 4. is a schematic view of a battery pack according to one embodiment of the disclosure; and

FIG. 5. is a schematic view of a battery cell according to one embodiment of the disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Effective management of hydrogen sulfide (H₂S) gas may increase the efficiency of solid-state battery systems, particularly in those utilizing lithium-sulfur technology. H₂S, a potential byproduct arising from the interaction of sulfur-based components with moisture, poses significant challenges to both the performance and reliability of battery systems. To effectively mitigate any performance effects it may have on the battery, the adoption of catalytic materials is proposed. Among these, Ni/Ce, Cu/Zeolite, and Fe/Zeolite have shown potential, either used individually, in combination, or alongside other catalysts, for their efficacy in absorbing and transforming H₂S gas.

This disclosure explores approaches of employing sulfidolytic coatings within sulfur-containing lithium-based rechargeable battery environments to mitigate H₂S. These coatings are applied to the interior surfaces of pouch cells and externally to battery stacks. They are configured to react with H₂S gas, generated from moisture ingress in sulfur-based components, converting it into sulfur dioxide and water. The coatings incorporate catalytic materials, specifically Ni/Ce, Cu/Zeolite, or Fe/Zeolite, to facilitate this conversion process. Application methods for these catalysts include atomic layer deposition, vapor deposition, or 3D printing, chosen for their ability to achieve uniform coatings critical for effective catalysts.

The sulfur-containing lithium-based rechargeable batteries have—anodes, cathodes, and are supported by a range of electrolytes, including inorganic solid electrolytes, solid polymer electrolytes, and composite polymer electrolytes. The batteries are encased in pouches, which may be composed of composite materials or polymer-based substances, depending on the specific application requirements. Additionally, battery packs may incorporate an external sulfidolytic coating on the stacks, for H₂S mitigation. Enclosures around these battery stacks may be equipped with mechanisms for selective venting of sulfur dioxide and water, for controlled emission management. This addresses H₂S emissions and may also contribute to battery longevity.

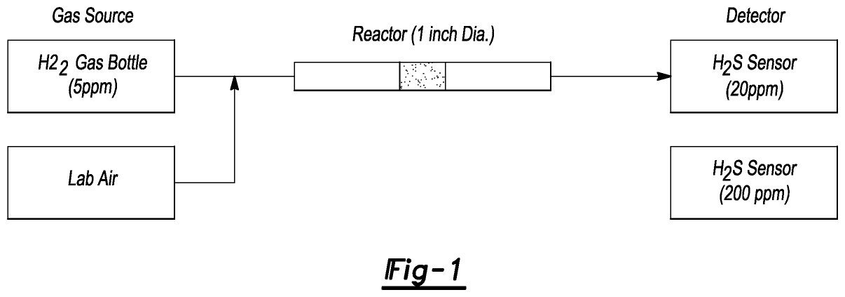

To understand the efficiency and functionality of various catalysts in the absorption of H₂S, an experimental setup was established as depicted in FIG. 1. This setup aimed to closely mimic the conditions under which these catalysts would operate within a battery pack environment, focusing on their ability to mitigate H₂S emissions. The experiment utilized a gas source to mix H₂S with laboratory air, delivering it at an amount of 5 parts per million (ppm) and a flow rate of 1000 ml/min through a reactor. This reactor, with dimensions of 1 inch in diameter and length, was subjected to the gas mixture and then linked to a sensor designed to measure the H₂S levels emitted post-reactor interaction. The experimental setup also included the use of a video camera to continuously record the H₂S sensor readings and the corresponding time, enabling the construction of an H₂S versus Time Curve for each test condition.

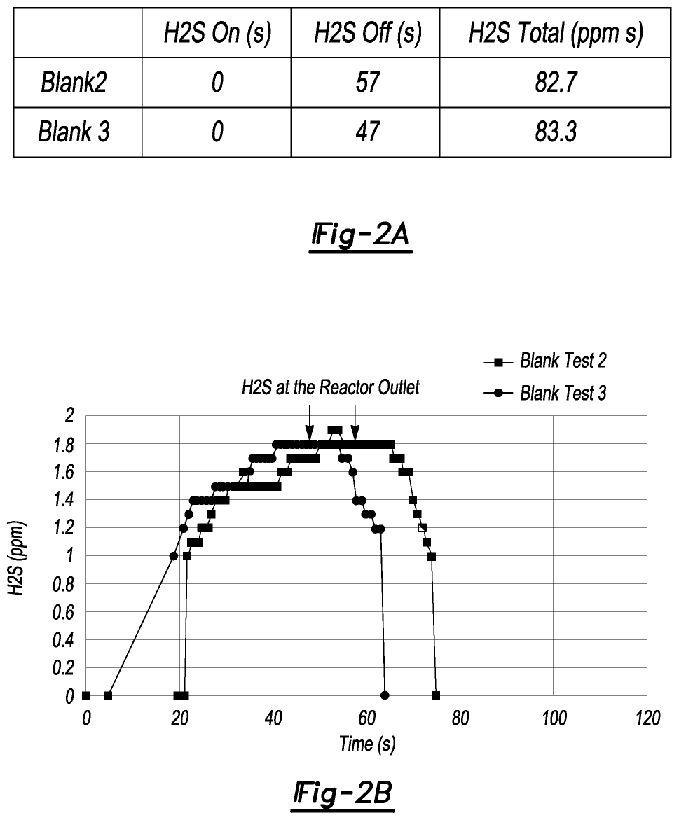

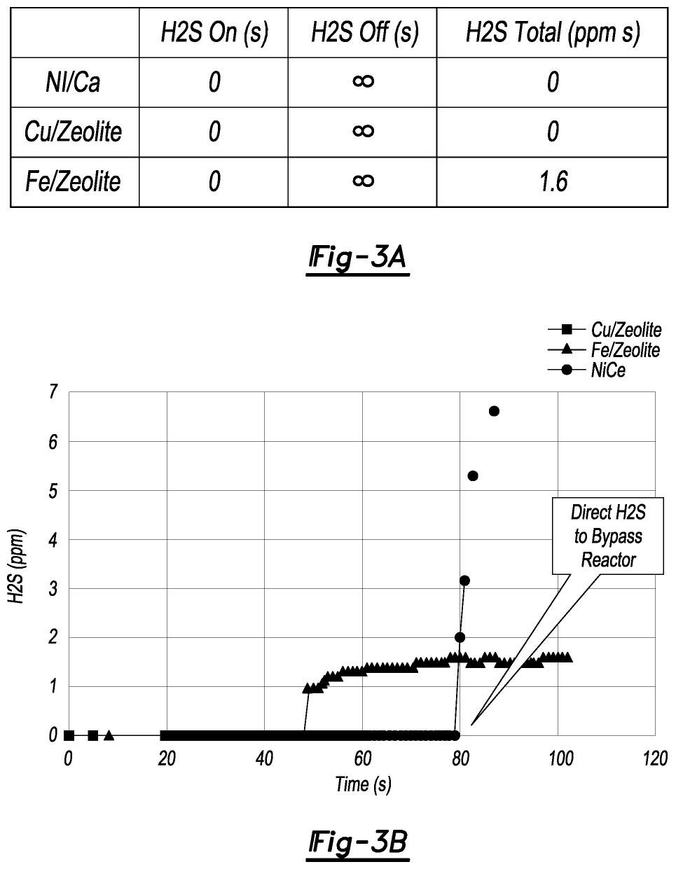

Prior to the introduction of any catalyst materials into the reactor, a background test was conducted using a blank reactor setup to establish a baseline for H₂S emissions. This was followed by individual tests for each of the selected catalyst materials: Ni/Ce, Cu/Zeolite, and Fe/Zeolite. The findings from the background tests, as illustrated in FIGS. 2A and 2B, showed H₂S readings of 82.7 and 83.3 ppm after 57 and 47 seconds, respectively, indicating the presence of H₂S in the absence of a catalyst. In contrast, the implementation of catalyst materials within the reactor showed a reduction in H₂S emissions. As seen in FIGS. 3A and 3B, the presence of Ni/Ce and Cu/Zeolite catalysts within the reactor material resulted in minimal H₂S readings at the sensor even after extended periods of gas release. This difference underscores the effectiveness of these catalysts in absorbing H₂S under the test conditions, which were set to closely replicate room temperature environments. Both Ni/Ce and Cu/Zeolite demonstrated the ability to absorb H₂S effectively at room temperature, as evidenced by the minimal H₂S readings recorded after the gas passed through reactors containing these catalysts. Fe/Zeolite was found to be less effective in absorbing H₂S under the same temperature conditions. The choice of catalyst selected may be influenced by environmental conditions of the application site and desired outcomes.

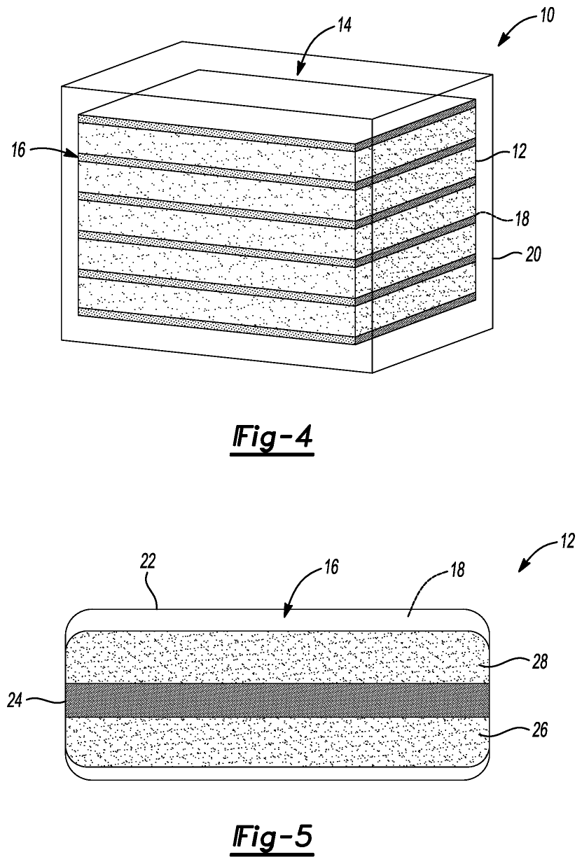

Referring to FIGS. 4-5, FIG. 4 is a schematic view of a battery pack 10. The battery pack 10 has a plurality of solid-state lithium-sulfur battery cell assemblies 12 packaged together defining a stack 14. A sulfidolytic coating 16, is applied on opposite exterior surfaces of the stack 14. The sulfidolytic coating 16 is configured to mitigate hydrogen sulfide gas generation, a byproduct of moisture interaction with a sulfur-based component. The sulfidolytic coating 16 is configured to do this through the incorporation of catalyst materials 18. The catalyst materials 18 in the coating 16 initiate hydrolyzation, a chemical process that cleaves the H₂S molecules, converting them into substances such as water and sulfur dioxide. This conversion is what makes the coating 16 sulfidolytic. The sulfur dioxide and water are subsequently released external to the battery cell 12 or battery pack 10.

In some configurations, the battery pack 10 may include an enclosure 20. The enclosure 20 may be configured to permit selective venting of sulfur dioxide and water. The selective venting may be accomplished by a pressure valve or other configurations to achieve selective venting. Mitigating the hydrogen sulfide externally may help to preserve the cell's integrity and lifespan. The catalyst materials 18 that may be used are Ni/Ce, Cu/Zeolite, and Fe/Zeolite individually or in combination, to facilitate the hydrolyzation of hydrogen sulfide gas into sulfur. The sulfidolytic coating 16 may be applied to the stack 14 using atomic layer deposition, vapor deposition, 3D printing, or other suitable processes.

As shown in FIG. 5, each of the individual cells 12 within the battery pack 10 are sulfur-containing lithium-based rechargeable battery cells. Although shown applied to pouch cells 12, the sulfidolytic coating 18 may be used with other battery cell arrangements such as prismatic cells. The individual cells have a pouch 22 with sulfidolytic coating 16 applied to an interior surface of the pouch 22. The pouch 22 may be made of a composite of two different materials. In other configurations, the pouch 22 may be polymer-based depending upon the requirements of the application. The individual cells 12 include a solid electrolyte 24 sandwiched between an anode 26 and a cathode 28. Similarly, the sulfidolytic coating 16 is configured to mitigate hydrogen sulfide gas generation, a byproduct of moisture interaction with the cathode 28.

The electrolyte 24 may be any compatible electrolyte such as inorganic solid electrolyte (ISE), solid polymer electrolyte (SPE), or composite polymer electrolyte (CPE). The sulfidolytic coating 16 is configured to do this through the incorporation of catalyst materials 18 hydrolyzing hydrogen sulfide gas into sulfur dioxide and water. The sulfur dioxide and water are subsequently released external to the battery cell 12. The same catalyst materials 18 Ni/Ce, Cu/Zeolite, and Fe/Zeolite individually or in combination, may be used to facilitate the hydrolyzation of hydrogen sulfide gas into sulfur. In a similar process as done with the stack 14, the sulfidolytic coating 16 may be applied to the cells 12 using atomic layer deposition, vapor deposition, 3D printing, or other suitable processes.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A battery comprising:
a sulfur-containing lithium-based rechargeable battery cell assembly including a casing having a sulfidolytic coating applied to an interior surface thereof, and a cell, having an anode, a cathode, and an electrolyte therebetween, configured to precipitate hydrogen sulfide gas responsive to moisture ingress in the cathode such that the sulfidolytic coating exudes sulfur dioxide and water into the casing.

2. The battery of claim 1 wherein the sulfidolytic coating includes a catalyst material.

3. The battery of claim 2 wherein the catalyst material is selected from a group comprising Ni/Ce, Cu/Zeolite, Fe/Zeolite, and combinations thereof.

4. The battery of claim 1 wherein the electrolyte is selected from a group comprising inorganic solid electrolyte, solid polymer electrolyte, and composite polymer electrolyte.

5. The battery of claim 1 wherein the casing is a composite.

6. The battery of claim 1 wherein the casing is polymer-based.

7. The battery of claim 1 wherein the sulfidolytic coating is applied using atomic layer deposition, vapor deposition, or 3D printing.

8. A battery pack comprising:
a plurality of sulfur-containing lithium-based rechargeable battery cell assemblies defining a stack; and
a sulfidolytic coating, on opposite exterior surfaces of the stack, configured to precipitate hydrogen sulfide gas responsive to moisture ingress in the sulfur-containing lithium-based rechargeable battery cell assemblies such that the sulfidolytic coating exudes sulfur dioxide and water.

9. The battery pack of claim 8 wherein the sulfidolytic coating includes a catalyst material.

10. The battery pack of claim 9 wherein the catalyst material is selected from a group comprising Ni/Ce, Cu/Zeolite, Fe/Zeolite, and combinations thereof.

11. The battery pack of claim 8 wherein the sulfur-containing lithium-based rechargeable battery cell assemblies include a solid electrolyte.

12. They battery pack of claim 8 wherein the sulfidolytic coating is applied using atomic layer deposition, vapor deposition, or 3D printing.

13. The battery pack of claim 8, further comprising an enclosure around the stack configured to permit selective venting of sulfur dioxide and water.

14. A battery comprising:
a sulfur-containing lithium-based rechargeable battery cell having an anode, a cathode, and an electrolyte sandwiched therebetween; and
a coating, on opposite exterior surfaces of the sulfur-containing lithium-based rechargeable battery cell, configured to hydrolyze hydrogen sulfide gas into sulfur dioxide and water.

15. The battery of claim 14 wherein the coating includes a catalyst material.

16. The battery of claim 15 wherein the catalyst material is selected from a group comprising Ni/Ce, Cu/Zeolite, Fe/Zeolite, and combinations thereof.

17. The battery of claim 14 wherein the electrolyte is selected from a group comprising inorganic solid electrolyte, solid polymer electrolyte, and composite polymer electrolyte.

18. They battery of claim 14 wherein the coating is applied using atomic layer deposition, vapor deposition, or 3D printing.

19. The battery of claim 14 wherein the battery is a pouch cell.

20. The battery of claim 14 wherein the battery is a packaged with a plurality of battery cell assemblies defining a stack.
